(19) United States
(12) Patent Application Publication
(10) Pub. No.: US 2019/0370671 A1
(43) Pub. Date: Dec. 5, 2019

(54) SYSTEM AND METHOD FOR COGNITIVE ENGINEERING TECHNOLOGY FOR AUTOMATION AND CONTROL OF SYSTEMS

(71) Applicant: Siemens Aktiengesellschaft, Munich (DE)

(72) Inventors: Arquimedes Martinez Canedo, Plainsboro, NJ (US); Sanjeev Srivastava, Princeton Junction, NJ (US); Livio Dalloro, Plainsboro, NJ (US)

(21) Appl. No.: 16/477,241

(22) PCT Filed: Jan. 23, 2018
(86) PCT No.: PCT/US2018/014757

§ 371 Date: Jul. 11, 2019

Related U.S. Application Data
(60) Provisional application No. 62/449,756, filed on Jan. 24, 2017.

(51) Int. Cl. G06N 5/02; G06N 5/04; G06N 3/04; G06F 17/50; G06N 20/00

(52) U.S. Cl. CPC G06N 5/022; G06N 5/04; G06N 20/00; G06F 17/5009; G06N 3/0454

(57) ABSTRACT

A method of performing cognitive engineering comprises extracting human knowledge from at least one user tool, receiving system information from a cyber-physical system (CPS), organizing the human knowledge and the received system information into a digital twin graph (DTG), performing one or more machine learning techniques on the DTG to generate an engineering option relating to the CPS, and providing the generated engineering option to a user in the at least one user tool. The method may include recording a plurality of user actions in the at least one user tool, storing the plurality of user actions in chronological order to create a series of user actions, and storing historical data relating a plurality of stored series of user actions.

### CROSS REFERENCE TO RELATED APPLICATIONS

This application claims priority under 35 U.S.C. § 119(e) to U.S. Provisional Patent Application Ser. No. 62/449,756 filed Jan. 24, 2017 entitled, “CENTAUR: Cognitive Engineering Technology for Automation and Control”, which is incorporated by reference herein in its entirety.

### TECHNICAL FIELD

This application relates to automation and control. More particularly, this application relates to digitally modeling automation and control systems.

### BACKGROUND

Cyber-Physical Systems (CPSs) components such as Programmable Logic Controllers (PLC) are programmed to do a specific task, but they are incapable of achieving self-awareness. Moreover, current CPSs lack the capability of artificial intelligence (AI).

Currently, there are attempts to integrate AI into CPS. For example, recent research showed that PLCs and edge devices, such as smart sensors, can be programmed using AI techniques to achieve new capabilities. However, while machines can frequently outperform a human counterpart, machines can often be made to work more efficiently which the help of a human operator or designer. Devices and systems that provide greater capability by leveraging machine learning based on sensor data combined with human knowledge are desired.

### SUMMARY

According to aspects of embodiments of the present invention, a method of performing cognitive engineering comprises, extracting human knowledge from at least one user tool, receiving system information from a cyber-physical system (CPS), organizing the human knowledge and the received system information into a digital twin graph (DTG), performing one or more machine learning techniques on the DTG to generate an engineering option relating to the CPS, and providing the generated engineering option to a user in the at least one user tool.

According to an embodiment, the method further comprises recording a plurality of user actions in the at least one user tool, storing the plurality of user actions in chronological order to create a series of user actions, and storing historical data relating a plurality of stored series of user actions.

In an embodiment, the at least one user tool is a computer aided technology (CAx) engineering front end.

According to another embodiment, extracting human knowledge from the at least one user tool comprises recording, in a computer aided technology (CAx), a time series of modeling steps performed by a user. In other embodiments, extracting human knowledge from the at least one user tool comprises recording, in a computer aided technology (CAx), a time series of simulation setup steps performed by a user.

According to embodiments, extracting human knowledge from the at least one user tool comprises recording, in a computer aided technology (CAx), a time series of material assignment steps performed by a user.

According to aspects of other embodiments, the method of Claim 1, further comprises arranging the DTG in a layered architecture comprising a core containing the DTG, a first layer defining a digital twin interface language providing a common syntactic and semantic abstraction of domain-specific data, a second layer comprising components of a cognitive CPS, and a third layer comprising advanced CPS applications.

According to further embodiments, the components of the cognitive CPS comprise applications for providing self-awareness of the CPS, applications for providing self-configuration of the CPS, applications for providing self-healing through a resilient architecture of the CPS, and applications for generative design of components in the CPS. In some embodiments, the DTG is configured to change over time. The DTG may change over time through at least one of the following: an addition of a node; a removal of a node; an addition of an edge connecting two nodes; and a removal of an edge previously connected two nodes. Further, a change of the DTG occurring between a first point in time and a second point in time creates a causal dependency that may be used by the one or more machine learning techniques to generate the engineering option.

According to embodiments, the one or more machine learning techniques comprises reinforcement learning, generative adversarial networks, and/or deep learning.

In some embodiments, the DTG may comprise a plurality of sub-graphs, each of the sub-graphs representative of a component of the CPS, where an edge connecting a first sub-graph and a second sub-graph is representative of a relationship between a first component represented by the first sub-graph and a second component represented by the second sub-graph.

In other embodiments, the DTG comprises a plurality of nodes and a plurality of edges, each edge connecting two nodes of the plurality of nodes and each edge representative of a relationship between the associated two nodes, the relationship relating to data for improving a future design of the CPS.

A system for cognitive engineering according to aspects of embodiments of this disclosure comprise a database for extracting and storing user actions in at least one user tool, a cyber-physical system (CPS) comprising at least one physical component, a computer processor in communication with the database and the at least one physical component configured to construct a digital twin graph representative of the CPS, and at least one machine learning technique, executable by the computer processor and configured to generate at least one engineering option of the CPS. The system may further comprise an extraction tool, operable by the computer processor, configured to record and save a time-sequence of user actions performed in the at least one user tool and store a historical record of a plurality of time-sequences of user actions in the database. The at least one user tool may include a computer aided technology (CAx).

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a diagram of a digital twin graph according to aspects of embodiments of this disclosure.

FIG. 2 is a diagram of a system comprising a plurality of inter-related graphs according to aspects of embodiments of this disclosure.

FIG. 3 is an illustration of digital twin graph transformation over time according to aspects of embodiments of this disclosure.

FIG. 4 is an illustration of the use of product in use (PiU) data for intelligent design according to aspects of embodiments of this disclosure.

FIG. 5 is an illustration of a time line for achieving a future goal based on past experience according to aspects of embodiments of this disclosure.

FIG. 6 is a block diagram of an architecture for machine learning based on empirical data and extracted human knowledge according to aspects of embodiments of this disclosure.

FIG. 7 is a block diagram of a computer system for implementing aspects of embodiments of this disclosure.

### DETAILED DESCRIPTION

A cognitive engineering technology for automation and control (CENTAUR) is a transformational approach for the design, engineering, and operation of complex cyber-physical systems (CPS) where human knowledge is paired with artificial intelligent systems to jointly discover new automation and control approaches that are not previously known. The discovered approaches may achieve unprecedented levels of performance, reliability, resilience, and agility. A wall street quantitative analyst one said, “no man is better than a machine, and no machine is better than a man with a machine”. With this view, CENTAUR aims at creating CPSs, that in coordination with humans, behave similarly to living organisms in that they are aware of themselves and their environment (self-consciousness), design their own plans (self-planning), and identify problems and reconfigure themselves (self-healing). To realize this vision, Digital Twins are created, providing living digital representations of an operational environment (OE) that co-evolves with the real OE and the CPSs contained in it. CENTAUR is an example of how artificial intelligence systems coupled with knowledge derived from humans can transform CPS and the Internet-of-Things (IoT).

With the help of Digital Twins, CENTAUR has the potential to radically transform the way complex CPS's, for example high-speed trains, may be designed. Further, Digital Twins can also help improve how CPSs interact with each other in Systems-of-Systems (SoS) (e.g., factories with IoT devices). A system like CENTAUR can assist engineers to do what they are unable to do today, significantly expanding the problems they can solve and creating new ways of working. With such a system, engineers may develop superior strategies and design systems that achieve optimal outcomes while considering the effects of uncertainty and the unknowable factors. Below are five aspects where CENTAUR will have the highest impact:

1. Dealing with complexity. CENTAUR will help generate new insights from large amounts of information, while understanding the interactions and relationships among various elements of large systems. In this way future conditions may be predicted and unintended consequences resulting from design decisions may be better understood.

2. Capturing expertise and design intent across domains. CENTAUR will help us address the problem of the aging work force where experience and knowledge is lost due to attrition and allowing understanding of the “big picture” to address problems that cut across domains.

3. Data- and fact-driven decisions. Rather than relying on traditional human expertise, or being limited to what generative design methods impose, CENTAUR will be more objective when making decisions by providing hypotheses, scenarios, and inferences based on existing data.

4. Discovery. CENTAUR will help discover and explore new and contrarian ideas. Through extensive use of hybrid approaches that combine simulation and data, CENTAUR will use Digital Twins representing both existing and theoretical CPS. Experiments may be run “in-silico” rather than in real world systems.

5. Sensorial extensions. CENTAUR will allow processing of and making sense of vast amounts of raw data that describe the world. Cognitive engineering technology allows detection and discovery of information that human operators cannot reason about and allows use of these insights to improve existing and future designs.

### CENTAUR Architecture

Central to CENTAUR is data. State-of-the-art CPS practice emphasizes runtime data because many CPS are instrumented with sensors that monitor their performance. These CPS define flat semantic definitions that describe relationships between data items. However, these semantic definitions are static and cannot adapt to changing conditions, nor can they be updated based on analysis of past knowledge. This sensor data is readily available and can be exploited for useful applications that save millions of dollars in the operation of CPS. For example, Prognostics and Health Monitoring (PHM) applications currently deployed in large gas turbines (300 MW) is one of the competitive advantages that has helped maintained unprecedented efficiency (e.g., >60%). However, contrary to popular belief, runtime is not the only source of readily available CPS data. Rather, solutions may be found across the entire CPS value chain. From this vantage point, unique insights in the process of designing, engineering, manufacturing, operating, maintaining, and decommissioning CPS may be obtained. CENTAUR exploits, for the first time, two untapped sources of tremendously useful data: Engineering-at-Work (EaW), and Product-in-Use (PiU). The details about EaW and PiU are provided in more detail below.

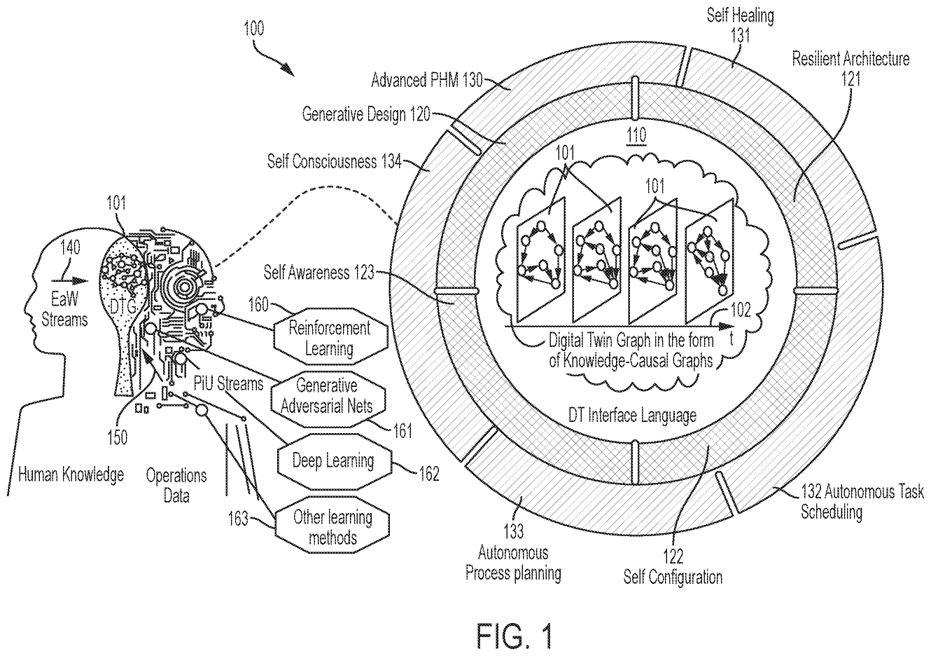

FIG. 1 is a diagram of a cognitive engineering architecture 100 according to aspects of embodiments of the present disclosure. The basic concept is to utilize two novel forms of the data—EaW (design data) streams 140 and PiU data streams 150 (runtime data)—to create and maintain Digital Twins of the CPS. Different digital twins can cover different aspects of both the physical and the cyber systems. Representing these twins in the form of a Digital Twin Graph 101 (realized by Knowledge-Causal Graphs) will enable semantic and causal connections that will automatically capture cross-cutting information/knowledge between different sub-systems, or in SoS. The knowledge-causal graphs may be viewed not as a snapshot of one point in time, but rather as a series of knowledge causal graphs spanning a portion of timeline 102. Seen as a layered architecture 100, the DTG 101 is at the core. In the first layer, a Digital Twin Interface Language 120 provides a common syntactic and semantic abstraction on the domain-specific data (e.g., time-series data, sensor data, control models, CAD models, etc.). This abstraction 120 will enable: a) a user to define custom queries; b) interactions with various machine learning (ML) tools; c) interactions to facilitate autonomous CPS functions; and d) interactions with databases. Using this language abstraction 120, various ML tools such as reinforcement learning 160, generative adversarial networks 161, and deep learning 162, along with other ML methods 163 may be utilized to create what may be called a “Cognitive CPS”. This concept is inspired by the ways a human body functions and exhibits abilities such as self-consciousness 134, self-healing, self-awareness 123, self-configuration 122, occurring apart from the intelligence which is distributed in edge devices but centrally controlled through the “brain”. The Cognitive CPS will act like a human body which is aware of what is happening in each subsystem of the CPS, and capable of acting autonomously to achieve its individual and collective goals including resilient architecture 131 and driving generative design 120. Thus, the third layer consists of advanced CPS applications such as advanced Prognostics and Health Monitoring (PHM) 130, autonomous task scheduling 132, and autonomous process planning 133. When coupled with a human and its human intelligence, CENTAUR will act more intelligently than any person, group, or computer has ever done before.

### Knowledge Representation and Alternative Data Sources in CENTAUR

To realize CENTAUR, a breakthrough in both knowledge representation and alternative data sources for CPS is introduced. First, knowledge representation is captured through a continuous influx of heterogeneous sources of information. The data is automatically extracted and used to construct a dynamic graph where machine learning algorithms can operate efficiently. In addition, alternative data sources are used in novel ways to provide novel insights for the design and operation of CPS. These challenges are overcome using a dynamic Digital Twin Graph and EaW and PiU data streams.

### Digital Twin Graph

A Digital Twin is a living digital representation of an object that co-evolves with the real object. Every object, and the interactions and interrelationships between objects are maintained in a web of linked-data sets referred to as the Digital Twin Graph (DTG). State-of-the-art linked-data approaches rely on a flat structure or graph that emphasizes semantics. However, this flat approach leaves out other very important dimensions including the evolution of the graph over time, known and emergent relationships between objects, uncertainty, and functional capabilities.

Accordingly, the DTG's goals are:
“expressive” in that it manages causal relationships that cannot be understood solely through logical expressions or first principles;
“agile” in that algorithms and humans will assemble, populate, configure, change, and resolve uncertainty in the knowledge representation;
and “adaptive” in that it integrates new expert knowledge sources during the process.

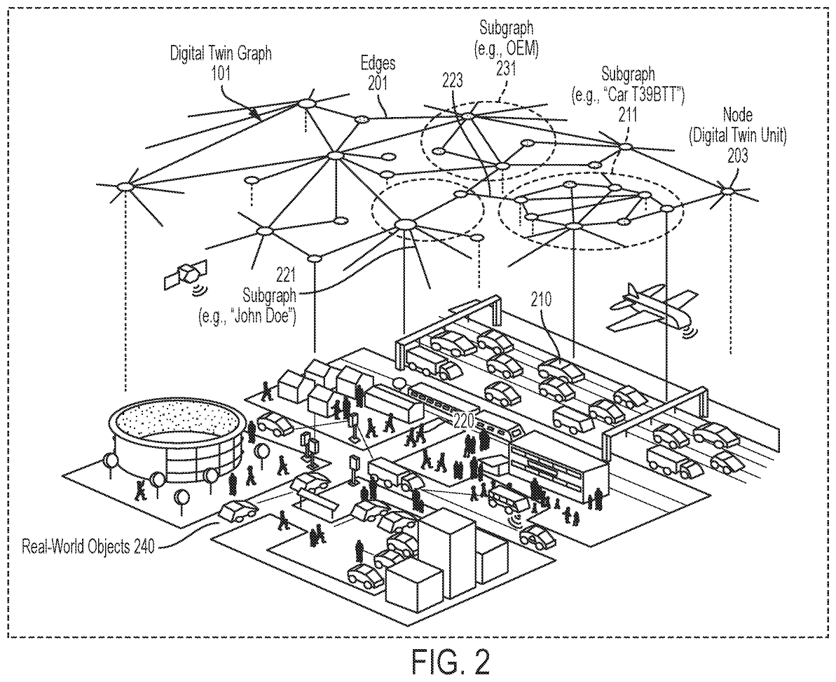

FIG. 2 shows how the DTG 101 is the information fabric where real-world objects 240 and their relationships are represented digitally. Real world internet-of-things (IoT) objects such as cars 210, people 220, buildings, airplanes, highways, houses, transportation systems are represented in the DTG. A real-world object is not represented by a single node, but by a subgraph 211, 221, 231 in the DTG 101. For example, a car “T39BTT” 210 is represented by multiple DTUs 203 in a subgraph 221. The DTUs in the subgraph 221 represent, for example, the CAD design, the service records, its current state (where it is, its speed, etc.), its manufacturing information (where it was produced, by which machines, etc.). Similarly, another subgraph 221 represents a person, “John Doe”, and its DTUs hold his identity, health records, agenda, etc. Notice that there is an edge 223 connecting “John Doe” to the car “T39BTT” via their corresponding subgraphs 221, 211, and this may represent, for example, that “John is currently driving the T39BTT car”. As soon as John arrives to his destination and turns off his car, this “driving” edge 223 will disappear from the DTG 101. Note that although the DTG 101 changes, all transactions are being recorded by the underlying DTG for further analysis. With the historical information between “John” and his “T39BTT” car it may, for example, be predicted when John will wake up the next morning to drive his car to work and the OEM 231 can use this information to push a software update to the car 210 through the air while John sleeps. This update by the OEM 231, also updates the DTG 101. Interactions like these are continuously updating the DTG 101. CENTAUR will go about reasoning under uncertainty using Hierarchical Dynamic Bayesian Models (HDBMs) synthesized from the DTG 101. The HDBMs will capture the operational environment's entities, their causal relationships, and beliefs about their state. Probabilistic inference algorithms will then extract timely insights from a continuous stream of information with rich structure and connections.

The DTG 101 is dynamic in the sense that the graph is continuously evolving with the creation and elimination of nodes 203 and edges 201. This is because the DTG 101 is continuously updated by data, queries, simulation, models, new providers, new consumers, and dynamic relationships between them. Even though the DTG 101 may consist of a large graph with billions of nodes 203 and edges 201, existing databases (e.g., GraphX, Linked Data) and algorithms (e.g. Pregel, MapReduce) running in cloud platforms may help to efficiently search and update the DTG 101. The DTG 101 representation is also suitable for a smooth integration with novel mathematical engines based on graph-theoretic and categorical approaches. The constant spatio-temporal evolution of the DTG 101 is captured in terms of a time-series of snapshots. The current snapshot of the DTG 101 reports the status of the operational environment (OE) and the OE's components such as CPS. Snapshots in the past provide a historical perspective that can be used to identify known patterns with supervised learning, and unknown patterns with unsupervised learning. After these learned models are created, the DTG 101 can also be used to predict outcomes.

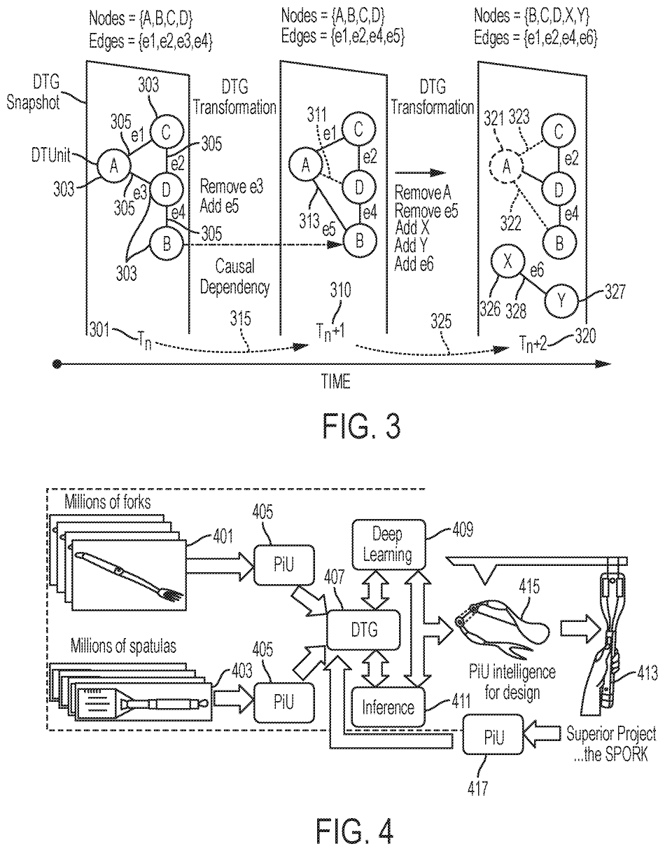

FIG. 3 is an illustration of snapshots of a DTG where a snapshot taken at Tn consists of four nodes 303 ({A, B, C, D}) and four edges 305 ({e1, e2, e3, e4}). The transition between Tₙ 301 and Tₙ+1 310 snapshots is referred to as a DTG Transformation 315 where the graph structure is modified by operations. In this case, the “remove e3” 311 and the “add e5” 313 edges. Thus, the resulting Tn+1 310 snapshot consists of four nodes ({A ,B, C, D} and four edges ({e1, e2, e4, e5}). The second transition 325 from Tₙ+1 310 to Tₙ+2 320 consists of “remove A” 321, “remove e5” 322, remove 31 323, “add X” 326, “add Y” 327, and “add e6” 328 operations. The resulting graph at Tₙ+2 320 consists of five nodes ({B, C, D, X, Y)} and three edges ({e2, e4, e6}). In practice, other graph architectures have been shown to scale to billions of changes per day. The DTG provides a flexible computational and data fabric for the Digital Twin.

Some advantages of DTGs may be better understood in terms of an example. For example, in a military scenario consider the problem of identifying a set of resources (allocated and unallocated) that may be cost-effectively (re-)tasked. Rather than simply identifying available resources that are known to perform a mission or task, the DTG can raise the problem to a functional dimension, decoupling the resource from the mission or task it can perform. This allows a break from siloed knowledge commonly arising in traditional linked-data approaches. Rather the resources may be viewed as a multi-functional, cross-agency, and highly agile force. Hence, this may lead to a novel solution for the resource identification problem where some of the identified resources may be from different domains/agencies, which would not have even been considered in the traditional approaches to solve the problem. This becomes possible in the DTG, because in a category theoretic sense, dimensions are categories, and relationships between categories are mappings (functors) that specify the interrelationships and dependencies among categories. A key enabler is that Category Theory is compositional, meaning that the knowledge stored in the DTG is dynamic (not static as in linked-data approaches), and new dimensions, relationships, and mappings may be continuously composed to generate new insights and determine equivalence of categories.

### Engineering-at-Work (EaW)

EaW data refers to the data that is generated by humans during design and engineering. For example, the CAx (Computer Aided X) front-end records the engineering actions as they are being applied to the tool (e.g., modeling steps, simulation setup, material assignment) as time-series data. These time-series recordings come from multiple engineers working on the same design process. The data can be anonymized to ensure that individual users can remain anonymous. These recordings are then stored in the DTG for machine learning algorithms that identify correlations between the requirements, constraints, and engineering decisions (embodied in actions) made by humans. The result is a decision support system that assists the human designer. When coupled with a human, the system can anticipate the human's next steps and act to correct any possible error, test the feasibility of a design decision, reduce the manual effort to setup simulation, and perform design space explorations. The human actions represented in the EaW data capture their individual expertise, judgement, intuition, creativity, cultural background, and morals. Accordingly, this EaW data may be viewed as extracted human knowledge. A Cognitive Design System with access to thousands of hours of EaW data could:
learn the “trade secrets” of the most experienced engineers and teach novice engineers;
generate human-machine interactions that are more natural to engineers and help them think and work differently;
materialize the design intent into explanations that help us better understand how design decisions translate to best outcomes;
provide new insights that might not have occurred to engineers on their own (e.g., “when you work with Alice the machinists are highly satisfied and are 15% more productive”).

EaW data streams are generated in engineering and design tools. User actions may be recorded and saved. The saved data may be automatically extracted from the user tools to provide a form of human knowledge. The workflow followed by a user in the user tools (e.g., the order of steps taken by a user) provides the story of “how” the user did what they did. The steps performed, and the order in which they are performed capture human behavior. The human behavior is representative of human knowledge. The stored knowledge may be incorporated into a digital twin graph and reused by machine learning techniques to improve current and future design choices and operation controls.

The EaW data streams are representative of the causality of changes over time. Instances of past actions are captured and provide more than just current states, but rather a time-series of different actions that define different digital twin graphs that change over the time interval of the EaW data streams.

### Product-in-Use (PiU)

PiU data can be easily confused with runtime data. PiU data refers to the data that a CPS is generating while it is in use that can be utilized to improve the design of the next-generation CPS. This is different from the runtime data that is generated while the CPS is in use but is used to optimize its future operation. In lifecycle terms, PiU enables a feedback loop from operation to (next-generation) design, while runtime data enables a feedforward loop from operation to (future) operation or maintenance. Another important difference between the two is that runtime data captures the behavior of a CPS relative to itself and its operation, while PiU data captures the behavior of a CPS relative to its environment and its interaction with other systems. For example, a car's rpm, temperature, and vibration are runtime data that can be used to optimize combustion and estimate wear and tear. The same car's location, geographical and meteorological conditions, driver demographics, and utilization patterns are PiU data that can be used to redesign its sunroof and make it more convenient to use. Therefore, a Cognitive Design System with access to PiU data could, for example:
give end users better functioning next-generation products that satisfy their real needs;
incorporate new requirements into the product design cycle quickly based on data and usage patterns rather than surveys or interviews;
automatically synthesize emergent requirements;
out-of-the-box condition monitoring and improvement of the software logic in deployed products (e.g., Tesla firmware updates over-the-air to improve the functionality of their cars);
cross-correlate multiple PiU sources from different products used by the same user to identify new products;
product development organizations can better segment their markets.

FIG. 4 is an illustration of a potential benefit of PiU. According to one non-limiting example, CENTAUR can parse through millions of pictures and videos of people having a barbecue. After labeling, millions of forks 401 and spatulas 403 are identified as utensils commonly used in barbecues. This knowledge in the form of PiU data streams 405, are represented in the DTG 407, may be used by Deep Learning 409 and inference algorithms 411 to generate insights and requirements for a potential new product 413, the “spork”, that combines the functionalities of both in a single utensil. Further PiU data 417 may be generated as the new product 413 is used and provided to update the DTG 407. Combined with the EaW, CENTAUR can then suggest the idea to the designers 415, and guide them step by step through the engineering process of the new product. The goal is to produce novel, useful, non-obvious products in a fraction of the time compared to the current product design practices.

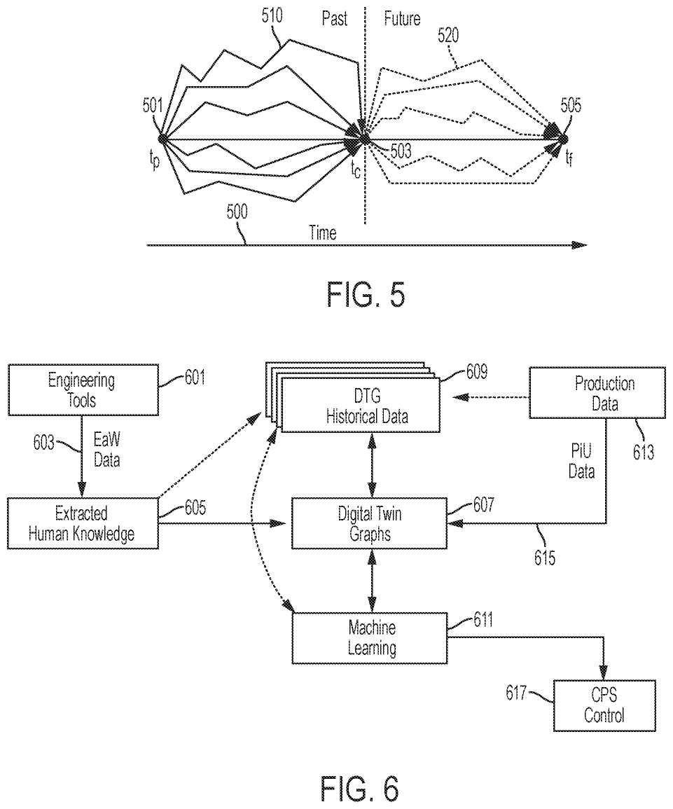

FIG. 5 is an illustration of a timeline 500 including a point of time in the past tₚ 501, a current time t_{c} 503, and a point of time in the future t_{f} 505. Future point 505 may be a goal to be attained. For example, the goal to be attained may be a level of service in the CPS. The goal may be attained in a number of ways. Paths 520 represent a number of ways in which the system may get from current point 503 to the goal at time 505. Similarly, the path between the past 501 and the current time 503 may include multiple paths 510. Using past knowledge, future actions may be developed and probabilistically analyzed base on a likelihood that the proposed actions will result in a successful outcome and achieve goal 505.

As stated above, the digital twin graphs according to the embodiments described in this disclosure are extended beyond conventional flat semantic constructs to adopt a probabilistic approach to the stored data. As such, the extracted and saved knowledge information in EaW data streams may be captured as a probabilistic distribution. Each edge and node of the DTG may be associated with a probability value. In some embodiments, the probability may be configured to fall between zero and one. A probability value of one may represent a predicted outcome that is relatively certain while a probability value near zero represents a predicted outcome that is less likely than a high probability value. Edges and their associated probability values represent uncertainty in the causal relationships in the DTG. By organizing edges as a probabilistic distribution, DTGs according to embodiments described herein can not only be viewed as True or False, but may represent likelihoods that fall between these extremes.

FIG. 6 is a block diagram of a cognitive engineering architecture according to aspects of embodiments of this disclosure. Engineering tools 601 capture human actions and the order of those actions and stores the actions over time. The actions define engineering at work data 603 which represents extracted human knowledge 605. The extracted human knowledge 605 is reflected in one or more digital twin graphs 607. The digital twin graphs 607 change over time, and past versions of the DTGs are stored as DTG historical data 609. The extracted human knowledge 605 is embodied in the DTG historical data 609 via the DTGs 607. Production data 613 may be captured by various states or conditions captured by sensors associated with components of a CPS system. The production data is provided as product in use data 615 to digital twin graphs 607. The Production data 613 is also present in the DTG historical data 609 via the DTGs 607. Machine learning techniques 611, including those described above in FIG. 1, act on the DTGs 607 and the DTG historical data 609 to produce optimized engineering and operations control actions. Engineering improvements are provided back to the DTGs 607 and provide engineers with solutions that are not achievable through other means. Optimized operations actions are provided to a controller of a CPS control system 617. The CPS provides the optimized control actions to the physical actuators and controls in the CPS.

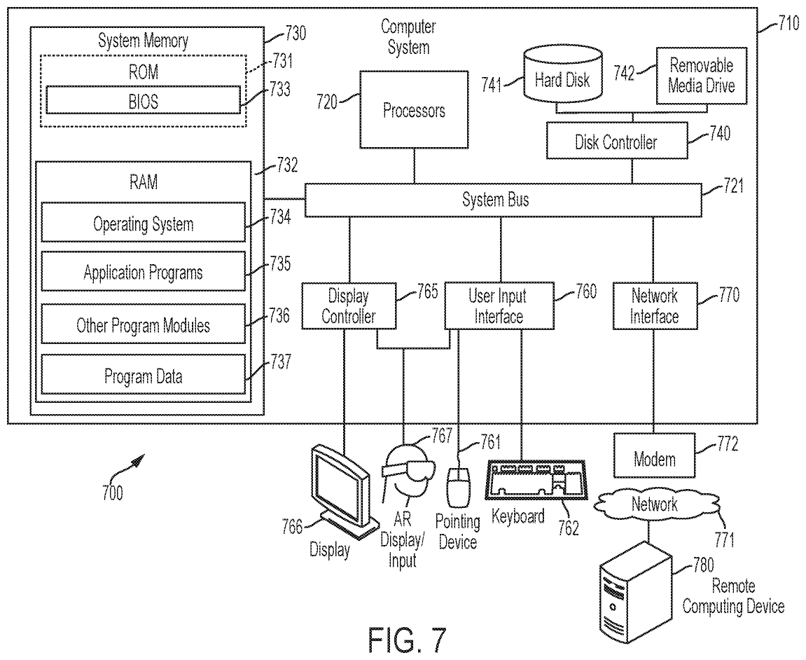

FIG. 7 illustrates an exemplary computing environment 700 within which embodiments of the invention may be implemented. Computers and computing environments, such as computer system 710 and computing environment 700, are known to those of skill in the art and thus are described briefly here.

As shown in FIG. 7, the computer system 710 may include a communication mechanism such as a system bus 721 or other communication mechanism for communicating information within the computer system 710. The computer system 710 further includes one or more processors 720 coupled with the system bus 721 for processing the information.

The processors 720 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 7, the computer system 710 also includes a system memory 730 coupled to the system bus 721 for storing information and instructions to be executed by processors 720. The system memory 730 may include computer readable storage media in the form of volatile and/or nonvolatile memory, such as read only memory (ROM) 731 and/or random access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application programs 735, other program modules 736 and program data 737.

The computer system 710 also includes a disk controller 740 coupled to the system bus 721 to control one or more storage devices for storing information and instructions, such as a magnetic hard disk 741 and a removable media drive 742 (e.g., floppy disk drive, compact disc drive, tape drive, and/or solid state drive). Storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the system bus 721 to control a display or monitor 766, such as a cathode ray tube (CRT) or liquid crystal display (LCD), for displaying information to a computer user. The computer system includes an input interface 760 and one or more input devices, such as a keyboard 762 and a pointing device 761, for interacting with a computer user and providing information to the processors 720. The pointing device 761, for example, may be a mouse, a light pen, a trackball, or a pointing stick for communicating direction information and command selections to the processors 720 and for controlling cursor movement on the display 766. The display 766 may provide a touch screen interface which allows input to supplement or replace the communication of direction information and command selections by the pointing device 761. In some embodiments, an augmented reality device 767 that is wearable by a user, may provide input/output functionality allowing a user to interact with both a physical and virtual world. The augmented reality device 767 is in communication with the display controller 765 and the user input interface 760 allowing a user to interact with virtual items generated in the augmented reality device 767 by the display controller 765. The user may also provide gestures that are detected by the augmented reality device 767 and transmitted to the user input interface 760 as input signals.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a magnetic hard disk 741 or a removable media drive 742. The magnetic hard disk 741 may contain one or more datastores and data files used by embodiments of the present invention. Datastore contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

The computing environment 700 may further include the computer system 710 operating in a networked environment using logical connections to one or more remote computers, such as remote computing device 780. Remote computing device 780 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 780). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. A method of performing cognitive engineering comprising:
extracting human knowledge from at least one user tool;
receiving system information from a cyber-physical system (CPS);
organizing the human knowledge and the received system information into a digital twin graph (DTG);
performing one or more machine learning techniques on the DTG to generate an engineering option relating to the CPS; and
providing the generated engineering option to a user in the at least one user tool.

2. The method of claim 1, further comprising:
recording a plurality of user actions in the at least one user tool;
storing the plurality of user actions in chronological order to create a series of user actions; and
storing historical data relating a plurality of stored series of user actions.

3. The method of claim 1, wherein the at least one user tool is a computer aided technology (CAx) engineering front end.

4. The method of claim 1, wherein extracting human knowledge from the at least one user tool comprises:
recording, in a computer aided technology (CAx), a time series of modeling steps performed by a user.

5. The method of claim 1, wherein extracting human knowledge from the at least one user tool comprises:
recording, in a computer aided technology (CAx), a time series of simulation setup steps performed by a user.

6. The method of claim 1, wherein extracting human knowledge from the at least one user tool comprises:
recording, in a computer aided technology (CAx), a time series of material assignment steps performed by a user.

7. The method of claim 1, further comprising:
arranging the DTG in a layered architecture comprising:
a core containing the DTG;
a first layer defining a digital twin interface language providing a common syntactic and semantic abstraction of domain-specific data;
a second layer comprising components of a cognitive CPS; and
a third layer comprising advanced CPS applications.

8. The method of claim 7, wherein the components of the cognitive CPS comprise:
applications for providing self-awareness of the CPS;
applications for providing self-configuration of the CPS;
applications for providing self-healing through a resilient architecture of the CPS; and
applications for generative design of components or sub-systems in the CPS.

9. The method of claim 1, wherein the DTG is configured to change over time.

10. The method of claim 9, wherein the DTG changes over time through at least one of the following:
an addition of a node;
a removal of a node;
an addition of an edge connecting two nodes; and
a removal of an edge previously connected two nodes.

11. The method of claim 10, wherein a change of the DTG occurring between a first point in time and a second point in time creates a causal dependency that may be used by the one or more machine learning techniques to generate the engineering option.

12. The method of claim 1, wherein the one or more machine learning techniques comprises reinforcement learning.

13. The method of claim 1, wherein the one or more machine learning techniques comprises generative adversarial networks.

14. The method of claim 1, wherein the one or more machine learning techniques comprises deep learning.

15. The method of claim 1, wherein the DTG comprises a plurality of sub-graphs, each of the sub-graphs representative of a component of the CPS.

16. The method of claim 15, wherein the DTG comprises an edge connecting a first sub-graph and a second sub-graph, the edge representative of a relationship between a first component represented by the first sub-graph and a second component represented by the second sub-graph.

17. The method of claim 1, wherein the DTG comprises a plurality of nodes and a plurality of edges, each edge connecting two nodes of the plurality of nodes and each edge representative of a relationship between the associated two nodes, the relationship relating to data for improving a future design of the CPS.

18. A system for cognitive engineering comprising:
a database for extracting and storing user actions in at least one user tool;
a cyber-physical system (CPS) comprising at least one physical component;
a computer processor in communication with the database and the at least one physical component configured to construct a digital twin graph representative of the CPS; and
at least one machine learning technique, executable by the computer processor and configured to generate at least one engineering option of the CPS.

19. The system of claim 15, further comprising:
an extraction tool, operable by the computer processor, configured to record and save a time-sequence of user actions performed in the at least one user tool and store a historical record of a plurality of time-sequences of user actions in the database.

20. The system of claim 15, wherein the at least one user tools comprises a computer aided technology (CAx).
